(19) United States
(12) Patent Application Publication
(10) Pub. No.: US 2024/0043726 A1
(43) Pub. Date: Feb. 8, 2024

(54) TWO-COMPONENT POLYURETHANE STRUCTURAL ADHESIVE WITH IMPROVED PROPERTIES

(71) Applicant: BOSTIK SA, Colombes (FR)

(72) Inventors: Federico SANZ, Venette (FR); Saida MULLER-SELLAK, Venette (FR)

(21) Appl. No.: 18/265,313

(22) PCT Filed: Dec. 7, 2021
(86) PCT No.: PCT/FR2021/052223

§ 371 Date: Jun. 5, 2023

(30) Foreign Application Priority Data
Dec. 16, 2020 (FR) FR2013362

(51) Int. Cl. C09J 175/04; C09J 11/06; C09J 11/04

(52) U.S. Cl. CPC C09J 175/04; C09J 11/06; C09J 11/04

(57) ABSTRACT

A PU2K structural adhesive composition comprising an —NCO component and a hardener component. The —NCO component and hardener component each comprise from 0.1% to 40% by weight of a thixotropic composition (A) comprising a bis-urea obtained by reaction of a primary aliphatic amine with a diisocyanate, in suspension in a continuous phase consisting of a plasticizer chosen from an alkyl phthalate and pentaerythritol tetravalerate; and at least one component, among the —NCO component and hardener component, comprises from 5% to 40% by weight of alumina. The structural adhesive is used in the field of construction, the manufacture of transportation means, preferably of the motor vehicle, rail and aerospace industries, and shipbuilding.

### FIELD OF THE INVENTION

A subject matter of the present invention is a two-component polyurethane structural adhesive composition (PU2K) exhibiting improved properties relating to sagging and to heat dissipation. The present invention also relates to the use of said composition.

### TECHNOLOGICAL BACKGROUND

Structural adhesives are well known for the production of assemblies, by adhesive bonding of the most diverse substrates (for example metal substrates), which can withstand stresses as great as the assemblies which are obtained by mechanical means, for example by screwing or by welding. The adhesive seal bonding the two substrates in such assemblies makes it possible to withstand very high mechanical tensile stresses, for example greater than 7 MPa, preferably greater than 20 MPa.

Such mechanical performance qualities for the adhesive seal can be obtained by two-component polyurethane structural adhesive compositions.

The latter compositions are provided in the form of two compositions (or components):
one (known as —NCO component) containing the chemical entities carrying isocyanate —NCO end groups, and
the other (known as hardener component) containing chemical entities carrying a group which reacts with the —NCO group, for example carrying a hydroxyl or amino end group.

These two components are often, for their use, packaged separately in the two compartments of a dual cartridge. The dispensing of the adhesive composition is thus performed, at the time of the application to the substrates to be assembled, by extrusion of the two components, for example using a dual-cartridge gun, and with their homogeneous mixture obtained, for example, by attaching a static mixer to the dual cartridge. The reaction of the —NCO reactive groups with, for example, the —OH groups (known as crosslinking reaction) which occurs from the mixing of the two components then has the effect of creating a solid three-dimensional polymeric network, which confers the desired mechanical properties on the adhesive seal created between the substrates to be assembled.

Among the implementational properties required for a two-component polyurethane structural adhesive composition, there is one which is of great importance in practice, relating to its antisagging behavior.

This is because the adhesive directly resulting from the mixing of the —NCO component and the hardener component is deposited (manually by an operator or by an automatic device) on a first well-defined surface of a 1^{st} substrate, in the form of a bead, the diameter of which can range up to 2 cm. This surface, thus treated with adhesive, is subsequently brought into contact with the second well-defined surface of a 2^{nd} substrate, after a certain period of time which can vary according to the open time of the adhesive.

However, it may happen that either the 1^{st} surface on which the bead of adhesive is initially deposited, or both substrates just after they have been brought into contact, are in a nonhorizontal position, in particular a vertical position, even though the crosslinking of the adhesive is not complete. This has the effect of exposing the bead(s) of the not yet crosslinked adhesive to the force of gravity and consequently to a risk of deformation or creep or even sagging (also described as “slump”), under the action of the stress resulting from said force.

Such a change in shape of the bead is designated in the remainder of the present text by the general term of “sagging”. It can thus have as consequence a variation in the thickness of the adhesive during crosslinking between the two substrates, and thus a nonhomogeneity, in particular a dimensional nonhomogeneity, of the adhesive seal which firmly bonds the two substrates in the final assembly obtained after complete crosslinking.

This nonhomogeneity of the adhesive seal is particularly likely to affect its mechanical properties, very particularly for an adhesive seal which has to withstand the very high mechanical stresses expected for a structural adhesive.

It is therefore particularly desirable to limit sagging for a two-component polyurethane structural adhesive composition, and even to eliminate it, under the conditions of its use.

The application FR 3 063 915 from Bostik describes an antisag agent consisting of a diurea obtained by reaction of an aromatic diisocyanate with an aliphatic amine, in the form of a suspension of solid particles of said diurea, in a specific plasticizer as continuous phase. This patent application also describes a one-component mastic adhesive composition based on polyurethane prepolymer having —NCO end groups which comprises from 5% to 25% by weight of said agent. However, the tensile strength properties of the adhesive seal obtained by crosslinking of said composition with atmospheric moisture are not appropriate to the resistance to the stresses likely to be applied to a structural adhesive, for example to mechanical tensile stresses of greater than 7 MPa. In addition, the crosslinking rate of a one-component polyurethane adhesive is generally much slower than that of a PU2K.

The application FR 3 079 840 from Bostik describes a specific two-component polyurethane structural adhesive composition, the —NCO component of which has a content by weight of diisocyanate monomer, which is potentially dangerous to the handling and the health of users, which is less than or equal to 0.1%. The —NCO component and the hardener component of this composition each comprise a rheology agent consisting of a micronized amide wax.

However, it is still very desirable to provide other two-component polyurethane structural adhesive compositions which, while making it possible to limit or even eliminate sagging during their use, exhibit other improved properties concerning the crosslinked adhesive seal, which are important in practice.

Thus, structural adhesives of the PU2K type are increasingly used in the field of transportation, for example to assemble elements of batteries intended for electric cars or for hybrid cars, or also to assemble metal parts in the vicinity of a heat engine. Thus, concerning a battery, the recharging of which is accompanied by an increase in temperature, it is important to limit as much as possible said increase, which is likely to degrade certain electronic circuits or also to reduce the lifetime of the battery. To do this, any improvement in the heat dissipation of the constituent elements of said battery is important, and in particular the heat dissipation of the adhesive seals employed to assemble said elements.

There consequently exists a need to improve the heat dissipation of the adhesive seal included in the assemblies concerned.

It is thus an aim of the present invention to provide a two-component polyurethane structural adhesive composition which makes it possible to solve the two-fold problem:
of improvement of the heat dissipation of the adhesive seal obtained by reaction of the —NCO component with the hardener component, and
of resistance to sagging, during its application to the surface of the substrates to be assembled.

Another aim of the present invention is to provide a two-component polyurethane structural adhesive composition capable of forming, after crosslinking reaction between its two components, an adhesive seal which exhibits a tensile breaking stress of greater than 10 MPa, preferably of greater than 20 MPa.

Another aim of the present invention is to provide a two-component polyurethane structural adhesive composition which exhibits a rheological behavior suitable for the extrusion of the adhesive by the application devices, such as a dual-cartridge gun and static mixer.

It has now been found that these aims can be achieved, in all or in part, by means of the two-component polyurethane structural adhesive composition which is described below.

### DESCRIPTION OF THE INVENTION

A subject matter of the present invention is thus first a two-component polyurethane structural adhesive composition (PU2K) consisting of an —NCO component and of a hardener component, characterized in that:
the —NCO component and the hardener component each comprise from 0.1% to 40% by weight, based on the total weight of the corresponding component, of a thixotropic composition (A) comprising, based on its total weight:
   from 1% to 40% by weight of a bis-urea (a) obtained by reaction of a primary aliphatic amine (a1) with a diisocyanate (a2) with a molar mass of less than 500 g/mol, and
   from 60% to 99% by weight of a plasticizer (b) chosen from:
      an alkyl phthalate,
      pentaerythritol tetravalerate,
      an ester of alkylsulfonic acid and of phenol,
      diisononyl 1,2-cyclohexanedicarboxylate,
      3,3′- [methylenebis(oxymethylene)]bis[heptane], and
      dioctyl carbonate;
   said thixotropic composition (A) being provided in the form of a suspension (or dispersion) of solid particles of the bis-urea (a) in a continuous phase consisting of the plasticizer (b); and
at least one component, among the —NCO component and the hardener component, comprises from 5% to 40% by weight of alumina (B), based on the total weight of said component.

It has been found, by tests carried out by the applicant company, that the incorporation of the thixotropic composition (A) in each of the —NCO and hardener components makes it possible, combined with the presence of alumina (B), to limit, indeed even to eliminate, the undesirable effect of sagging of the PU2K structural adhesive composition, during the preparation of assemblies of substrates, one at least of which is in a nonhorizontal position, in particular a vertical position. Such an effect is moreover obtained without reducing the cohesion of the adhesive seal and its ability to resist very high stresses, of the level expected for a structural adhesive, and, moreover, while offering an increased thermal conductivity (or conductibility), corresponding to an improved heat dissipation.

Such a PU2K structural adhesive also retains its ability to be extruded using a standard gun, suitable for the dual cartridge fitted with a static mixer, in which it is packaged, which thus makes it overall a very advantageous product in practice, in all industrial fields, such as those of transportation, where there exists a need to improve the heat dissipation of the adhesive seal, for example for the assemblies of metal parts intended for the manufacture of batteries designed for electric or hybrid vehicles.

—NCO Component:

The —NCO component contains one or more chemical entities carrying isocyanate end groups.

According to one embodiment, the —NCO component comprises (one or more) polyisocyanates, which can be aliphatic (linear, branched or cyclic) or aromatic, and optionally substituted.

Preferably, the polyisocyanate included in the —NCO component is chosen from diisocyanates, triisocyanates and their mixtures.

According to one preferred embodiment, the diisocyanates are chosen from the group consisting of isophorone diisocyanate (IPDI), pentamethylene diisocyanate (PDI), hexamethylene diisocyanate (HDI), heptane diisocyanate, octane diisocyanate, nonane diisocyanate, decane diisocyanate, undecane diisocyanate, dodecane diisocyanate, 4,4′-methylenebis(cyclohexyl isocyanate) (4,4′-HMDI), norbornane diisocyanate, norbornene diisocyanate, cyclohexane-1,4-diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane (TMDI), 4-(isocyanatomethyl)octane-1,8-diisocyanate (TIN), 2,5-bis(isocyanatomethyl)bicyclo[2.2.1]heptane (2,5-NBDI), 2,6-bis(isocyanatomethyl)bicyclo[2.2.1]heptane (2,6-NBDI), 1,3-bis(isocyanatomethyl)cyclohexane (1,3-H6-XDI), 1,4-bis(isocyanatomethyl)cyclohexane (1,4-H6-XDI), xylylene diisocyanate (XDI) (especially m-xylylene diisocyanate (m-XDI)), toluene diisocyanate (especially toluene-2,4-diisocyanate (2,4-TDI) and/or toluene-2,6-diisocyanate (2,6-TDI)), diphenylmethane diisocyanate (especially diphenylmethane-4,4′-diisocyanate (4,4′-MDI) and/or diphenylmethane-2,4′-diisocyanate (2,4′-MDI)), tetramethylxylylene diisocyanate (TMXDI) (especially tetramethyl-meta-xylylene diisocyanate), an HDI or PDI allophanate having, for example, the following formulae (Y1) and (Y2):

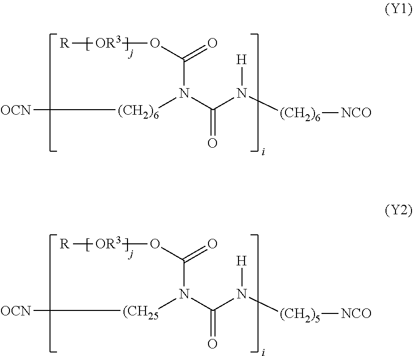

in which:
i is an integer ranging from 1 to 2,
j is an integer ranging from 0 to 9 and preferably 2 to 5,
R represents a saturated or unsaturated, cyclic or acyclic and linear or branched hydrocarbon chain comprising from 1 to 20 carbon atoms, preferably from 1 to 12 carbon atoms and more preferentially from 6 to 14 carbon atoms,
R³ represents a linear or branched divalent alkylene group having from 2 to 4 carbon atoms and preferably a divalent propylene group,

and of their mixtures.

The MDI can be in the form of an isomer or of a mixture of isomers, such as 4,4′-MDI and/or 2,4′-MDI.

The TDI can be in the form of an isomer or of a mixture of isomers, such as 2,4-TDI and/or 2,6-TDI.

The diisocyanates which can be used are widely available commercially. Mention may be made, by way of examples, of Scuranate® TX sold by Vencorex, corresponding to a 2,4-TDI with a purity of the order of 95%, Scuranate® T100 sold by Vencorex, corresponding to a 2,4-TDI with a purity of greater than 99% by weight, Desmodur® I sold by Covestro, corresponding to an IPDI, or else Isonate® M125 sold by Dow, corresponding to an MDI containing at least 97% of 4,4′-MDI.

According to another embodiment, the triisocyanates included in the —NCO component can be chosen from diisocyanate isocyanurates, adducts of diisocyanates and of triols, and biurets.

In particular, the isocyanurates can be used in the form of a technical mixture of (poly)isocyanurates with a purity of greater than or equal to 70% by weight of isocyanurates.

The diisocyanate isocyanurates which can be used according to the invention can correspond to the following general formula (W):

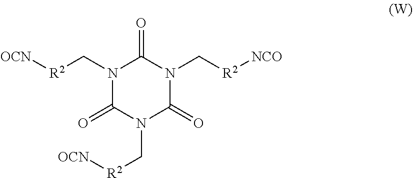

in which R2 represents a linear or branched, cyclic, aliphatic, arylaliphatic or aromatic alkylene group comprising from 4 to 9 carbon atoms,
with the proviso that the NCO groups are not connected by a covalent bond to a carbon atom forming part of an aromatic hydrocarbon ring, such as a phenyl group.

Mention may be made, as examples of diisocyanate isocyanurates which can be used according to the invention, of:
hexamethylene diisocyanate (HDI) isocyanurate:

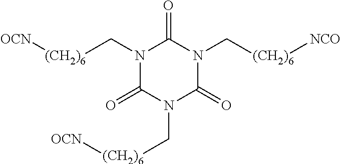

isophorone diisocyanate (IPDI) isocyanurate:

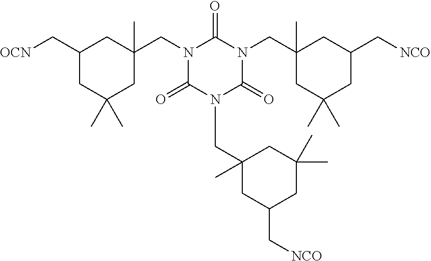

pentamethylene diisocyanate (PDI) isocyanurate:

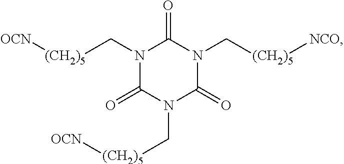

meta-xylylene diisocyanate (m-XDI) isocyanurate:

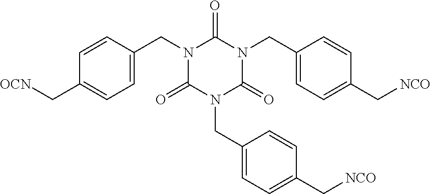

m-XDI isocyanurate, in hydrogenated form:

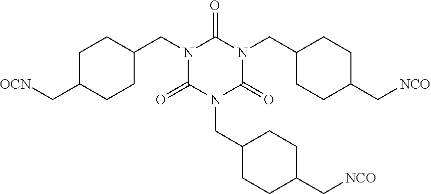

Diisocyanate isocyanurates are also commercially available. For example, HDI isocyanurates are sold by Bayer under the names Desmodur® N3300, N3600 and N3790BA or by Vencorex under the names Tolonate® HDT, HDT-LV and HDT-LV2.

The adducts of diisocyanate and triol can be prepared from diisocyanates which are preferably chosen from aromatic or aliphatic diisocyanate monomers and their mixtures and more preferentially aliphatic diisocyanate monomers. The diisocyanate monomers can be in the form of a pure isomer or in the form of a mixture of isomers.

Mention may be made, as triols which can be used to prepare the adducts of diisocyanate and triol, for example, of glycerol, trimethylolmethane (TMM), trimethylolethane (TME) and trimethylolpropane (TMP). Preferably, TMP is used.

Mention may be made, as examples of adducts of diisocyanates and of triols which can be used according to the invention, of the adduct of meta-xylylene diisocyanate and of trimethylolpropane, as represented below. This adduct is sold, for example, by Mitsui Chemicals under the name Takenate® D-110N.

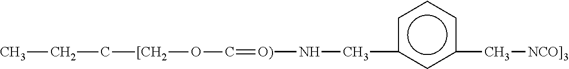

The biurets which can be used according to the invention are monomeric, oligomeric or polymeric biurets of hexamethylene diisocyanate (HDI), isophorone diisocyanate pentamethylene diisocyanate (PDI), meta-xylylene diisocyanate (m-XDI) or hydrogenated meta-xylylene diisocyanate (m-HXDI).

It is possible to give, as example of HDI biuret, the product of formula:

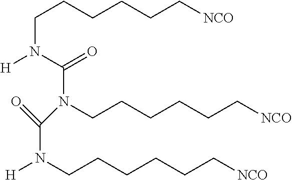

HDI biurets are, for example, sold by Bayer under the names Desmodur® N100 and N3200 or by Vencorex under the names Tolonate® HDB and HDB-LV.

According to a very particularly preferred alternative form of the invention, the triisocyanate included in the —NCO component of the PU2K structural adhesive composition is a hexamethylene diisocyanate (HDI) biuret.

Hardener Component:

The hardener component contains at least one chemical entity carrying a group which reacts with the isocyanate —NCO group, for example carrying a hydroxyl or amino end group or a mixture of such entities.

According to a 1^{st} preferred embodiment, the hardener component comprises a polyol or a mixture of polyols.

The polyols which can be used can be chosen from those having a number-average molar mass or molecular weight (Mn) ranging from 60 g/mol to 22 000 g/mol, preferably from 600 g/mol to 18 000 g/mol, preferably from 1000 g/mol to 12 000 g/mol, preferably from 1000 to 8000 g/mol and more preferentially still from 1000 g/mol to 4000 g/mol.

The number-average molecular weight of the polyols can be calculated from the hydroxyl number (OHN), expressed in mg KOH/g, and from the functionality of the polyol or determined by methods well known to a person skilled in the art, for example by size exclusion chromatography (or SEC) with PEG (polyethylene glycol) standard.

The polyols can have a hydroxyl functionality ranging from 2 to 6, preferably from 2 to 4, more preferentially still from 2 to 3. In the context of the invention, and unless otherwise mentioned, the hydroxyl functionality of a polyol is the mean number of hydroxyl functions per mole of polyol.

The polyols which can be used can be chosen from polyester polyols, polyether polyols, polydiene polyols, polycarbonate polyols, poly(ether-carbonate) polyols, prepolymers having —OH end groups and their mixtures.

The polyols which can be used can also be chosen from aliphatic polyols, arylaliphatic polyols, aromatic polyols, carbonate polyols and the mixtures of these compounds.

According to the invention, the polyester polyols can have a number-average molecular weight ranging from 500 g/mol to 22 000 g/mol, preferably from 700 g/mol to 10 000 g/mol and more preferentially still from 900 to 6000 g/mol.

Mention may be made, among the polyester polyols, for example, of:
polyester polyols of natural origin, such as castor oil;
polyester polyols resulting from the condensation:
   one or more aliphatic (linear, branched or cyclic) or aromatic polyols, such as, for example, ethanediol, 1,2-propanediol, 1,3-propanediol, glycerol, trimethylolpropane, 1,6-hexanediol, 1,2,6-hexanetriol, butenediol, cyclohexanedimethanol, sucrose, glucose, sorbitol, glycerol, trimethylolpropane, pentaerythritol, mannitol, triethanolamine, N-methyldiethanolamine and their mixtures, with
   one or more polycarboxylic acids or an ester or anhydride derivative thereof, such as 1,6-hexanedioic acid, dodecanedioic acid, azelaic acid, sebacic acid, adipic acid, 1,18-octadecanedioic acid, phthalic acid, succinic acid and the mixtures of these acids, an unsaturated anhydride, such as, for example, maleic or phthalic anhydride, or a lactone, such as, for example, caprolactone.

The abovementioned polyester polyols can be prepared conventionally and are for the most part commercially available.

Mention may be made, among the polyester polyols, for example, of the following products with a hydroxyl functionality equal to 2:
Tone® 0240 (sold by Union Carbide), which is a polycaprolactone with a number-average molecular weight of approximately 2000 g/mol and a melting point of approximately
Dynacoll® 7381 (sold by Evonik) with a number-average molecular weight of approximately 3500 g/mol and having a melting point of approximately 65° C.,
Dynacoll® 7360 (sold by Evonik), which results from the condensation of adipic acid with hexanediol and has a number-average molecular weight of approximately 3500 g/mol and a melting point of approximately 55° C.,
Dynacoll® 7330 (sold by Evonik) with a number-average molecular weight of approximately 3500 g/mol and having a melting point of approximately 85° C.,
Dynacoll® 7363 (sold by Evonik), which also results from the condensation of adipic acid with hexanediol and has a number-average molecular weight of approximately 5500 g/mol and a melting point of approximately 57° C.,
Dynacoll® 7250 (sold by Evonik): polyester polyol having a viscosity of 180 Pa·s at 23° C., a number-average molecular weight Mn equal to 5500 g/mol and a Tg equal to −50° C.,
Kuraray® P-6010 (sold by Kuraray): polyester polyol having a viscosity of 68 Pa·s at 23° C., a number-average molecular weight equal to 6000 g/mol and a Tg equal to −64° C.,
Kuraray® P-10010 (sold by Kuraray): polyester polyol having a viscosity of 687 Pa·s at 23° C. and a number-average molecular weight equal to 10 000 g/mol.

According to a preferred embodiment, the polyester polyol is chosen from a polycaprolactone; castor oil; a polyester polyol resulting from the condensation of ethylene glycol, propylene glycol, 1,3-propanediol and/or 1,6-hexanediol with adipic acid and/or the various isomers of phthalic acid; and their mixtures.

According to a preferred embodiment, the polyol (or mixture of polyols) included in the hardener component of the PU2K structural adhesive composition according to the invention is a polyether polyol (or a mixture of polyether polyols). According to the invention, the polyether polyols can have a number-average molecular weight ranging from 200 g/mol to 22 000 g/mol, preferably from 600 g/mol to 18 000 g/mol, preferably from 1000 g/mol to 12 000 g/mol and more preferentially still from 1000 to 4000 g/mol.

Preferably, the polyether polyols have a hydroxyl functionality ranging from 2 to 4, more preferentially still from 2 to 3.

The polyether polyols which can be used according to the invention are preferably chosen from polyoxyalkylene polyols, the linear or branched alkylene part of which comprises from 1 to 4 carbon atoms, preferably from 2 to 3 carbon atoms.

More preferentially, the polyether polyols which can be used according to the invention are chosen from polyoxyalkylene diols or polyoxyalkylene triols and better still polyoxyalkylene diols, the linear or branched alkylene part of which comprises from 1 to 4 carbon atoms, preferably from 2 to 3 carbon atoms.

Mention may be made, as examples of polyoxyalkylene diols or triols which can be used according to the invention, for example, of:
polyoxypropylene diol or triol (also denoted by polypropylene glycol (PPG) diol or triol) having a number-average molecular weight ranging from 400 g/mol to 22 000 g/mol and preferably ranging from 400 g/mol to 12 000 g/mol,
polyoxyethylene diol or triol (also denoted by polyethylene glycol (PEG) diol or triol) having a number-average molecular weight ranging from 400 g/mol to 22 000 g/mol and preferably ranging from 400 g/mol to 12 000 g/mol,
polyoxybutylene glycol (also denoted by polybutylene glycol (PBG) diol or triol) having a number-average molecular weight ranging from 200 g/mol to 12 000 g/mol,
PPG/PEG/PBG copolymer or terpolymer diol or triol having a number-average molecular weight ranging from 400 g/mol to 22 000 g/mol and preferably ranging from 400 g/mol to 12 000 g/mol,
polytetrahydrofuran (PolyTHF) diol or triol having a number-average molecular weight ranging from 250 g/mol to 12 000 g/mol,
polytetramethylene glycol (PTMG) having a number-average molecular weight ranging from 200 g/mol to 12 000 g/mol,
and their mixtures.

Preferably, the polyether polyols which can be used are chosen from polyoxypropylene diols or triols. The abovementioned polyether polyols can be prepared conventionally and are widely available commercially. They can, for example, be obtained by polymerization of the corresponding alkylene oxide in the presence of a catalyst based on a double metal/cyanide complex.

Mention may be made, as examples of polyether diols, of the polyoxypropylene diols sold under the name Acclaim® by Covestro, such as Acclaim® 18200, with a number-average molecular weight in the vicinity of 18 700 g/mol, Acclaim® 12200, with a number-average molecular weight in the vicinity of 11 335 g/mol, Acclaim® 8200, with a number-average molecular weight in the vicinity of 8057 g/mol, and Acclaim® 4200, with a number-average molecular weight in the vicinity of 4020 g/mol, or also of the polyoxypropylene diol sold under the name Voranol P2000 by Dow, with a number-average molecular weight in the vicinity of 2004 g/mol.

Mention may be made, as example of polyether triols, of the polyoxypropylene triol sold under the name Voranol CP3355 by Dow, with a number-average molecular weight in the vicinity of 3554 g/mol.

The polydiene polyols which can be used according to the invention can preferably be chosen from polydienes comprising hydroxyl end groups, and their corresponding hydrogenated or epoxidized derivatives.

Preferably, the polydiene polyols which can be used according to the invention are chosen from polybutadienes comprising hydroxyl end groups, which are optionally hydrogenated or epoxidized. Preferentially, the polydiene polyols which can be used according to the invention are chosen from butadiene homopolymers and copolymers comprising hydroxyl end groups, which are optionally hydrogenated or epoxidized.

In the context of the invention, and unless otherwise mentioned, the term “hydroxyl end groups” of a polydiene polyol is understood to mean the hydroxyl groups located at the ends of the main chain of the polydiene polyol.

The abovementioned hydrogenated derivatives can be obtained by complete or partial hydrogenation of the double bonds of a polydiene comprising hydroxyl end groups, and are thus saturated or unsaturated.

The abovementioned epoxidized derivatives can be obtained by chemoselective epoxidation of the double bonds of the main chain of a polydiene comprising hydroxyl end groups, and thus comprise at least one epoxy group in their main chain.

Mention may be made, as examples of polybutadiene polyols, of saturated or unsaturated butadiene homopolymers comprising hydroxyl end groups, which are optionally epoxidized, such as, for example, those sold under the name Poly bd® or Krasol® by Cray Valley.

Mention may be made, as examples of polycarbonate diols, of Converge Polyol 212-10 and Converge Polyol 212-20 sold by Novomer, respectively with number-average molecular weights (Mn) equal to 1000 and 2000 g/mol, the hydroxyl numbers of which are respectively 112 and 56 mg KOH/g, Desmophen® C XP 2716 sold by Covestro, with a number-average molecular weight (Mn) equal to 326 g/mol, the hydroxyl number of which is 344 mg KOH/g, and Polyol C-590, C-1090, C-2090 and C-3090 sold by Kuraray, having a number-average molecular weight (Mn) ranging from 500 to 3000 g/mol and a hydroxyl number ranging from 224 to 37 mg KOH/g.

According to a very particularly advantageous alternative form of the invention, which is preferably combined with that described above for the —NCO component, the hardener component included in the two-component polyurethane structural adhesive composition (PU2K) comprises:
at least two polyether polyols P1 each having a number-average molecular weight strictly of less than 500 g/mol, said polyether polyols P1 being such that:
   at least one polyether polyol P1 comprises at least three hydroxyl functions, preferably at least four hydroxyl functions; and
   at least one polyether polyol P1 comprises at least two hydroxyl functions; and
at least one polyether polyol P2 having a number-average molecular weight strictly of greater than 1000 g/mol.

Polyether Polyols P1:

Preferably, the hardener component comprises:
at least one polyether polyol P1 comprising at least three hydroxyl functions, preferably at least four hydroxyl functions; and
at least one polyether polyol P1 comprising two hydroxyl functions, preferably comprising at least one arylene radical.

According to one embodiment, the polyether polyols P1 each have a number-average molecular weight ranging from 100 g/mol to less than 500 g/mol, preferably from 200 g/mol to less than 500 g/mol, preferentially from 300 g/mol to less than 500 g/mol, advantageously from 400 g/mol to less than 500 g/mol and more advantageously still from 400 g/mol to 490 g/mol.

Preferably, the polyether polyols P1 each have a (mean) hydroxyl number (OHN) ranging from 224 to 2244 milligrams of KOH per gram of polyol (mg KOH/g), preferably from 224 to 1122 mg KOH/g, preferentially from 224 to 748 mg KOH/g and more preferentially still from 229 to 561 mg KOH/g.

Mention may be made, among the polyether polyols P1, for example, of Dianol® 330 (propoxylated 4,4′-isopropylidenediphenol having an OHN of approximately 280 mg KOH/g) sold by CECA or Lupranol® 3402 (propoxylated ethylenediamine having a functionality of 4 and an OHN of approximately 470 mg KOH/g) sold by BASF.

Polyether Polyols P2:

The hardener component comprises at least one polyether polyol P2 having a number-average molecular weight strictly of greater than 1000 g/mol, preferably of less than or equal to 10 000 g/mol, preferentially of less than or equal to 5000 g/mol and advantageously of less than or equal to 3000 g/mol.

Polyether diols are more particularly preferred, and among them polyoxyalkylene diols, such as polyoxypropylene diols.

Mention may be made, as examples of such commercially available products, of the polyoxypropylene diol sold under the name Voranol® P 1010 by Dow with a number-average molecular weight (Mn) in the vicinity of 1020 g/mol and the hydroxyl number of which is approximately 110 mg KOH/g, or the Voranol® P2000 sold by Dow with a number-average molecular weight in the vicinity of 2040 g/mol and the hydroxyl number of which is approximately 55 mg KOH/g.

According to a 2^{nd} embodiment of the invention, the hardener component comprises a compound carrying amino end groups, preferably a polyamine having two or more amino groups per mole, preferably a polyoxyalkylene polyamine (or polyetheramine). Preferably, the polyoxyalkylene polyamine has from 2 to 4 amino groups per mole and more preferentially from 2 to 3 amino groups per mole. The polyoxyalkylene polyamine generally has a number-average molar mass or molecular weight (Mn) of approximatelyl40 or more and preferably of approximately 200 or more. The polyoxyalkylene polyamine preferably has a number-average molecular weight (Mn) ranging from 200 to 5000 g/mol or less, preferably from 200 to 4000 g/mol and preferably from 200 to 2000 g/mol. Mention may be made, among the preferred polyoxyalkylene polyamines, of the polypropylene oxide triamine Jeffamine® T403 having a number-average molecular weight (Mn) of approximately 440 g/mol, the polypropylene oxide diamine Jeffamine® D-400 having a number-average molecular weight (Mn) of approximately 430 g/mol and the polypropylene oxide diamine Jeffamine® D-2000 having a number-average molecular weight (Mn) of approximately 2000 g/mol which are available from Huntsman.

Thixotropic Composition (A):

The two-component polyurethane structural adhesive composition (PU2K) according to the invention is such that its —NCO component and its hardener component each comprise from 0.1% to 40% by weight, based on the total weight of the corresponding component, of a thixotropic composition (A) which comprises, based on its total weight:
from 1% to 40% by weight of a bis-urea (a) obtained by reaction of a primary aliphatic amine (a1) with a diisocyanate (a2) with a molar mass of less than 500 g/mol; and
   from 60% to 99% by weight of a plasticizer (b) chosen from:
      an alkyl phthalate, preferably DiIsoDecyl Phthalate (DIDP);
      pentaerythritol tetravalerate;
      an ester of alkylsulfonic acid and of phenol;
      diisononyl 1,2-cyclohexanedicarboxylate;
      3,3′-[methylenebis(oxymethylene)]bis[heptane]; and
      dioctyl carbonate.

The thixotropic composition (A) is thus a suspension (or dispersion) of solid particles of the bis-urea (a) in a continuous phase consisting of the plasticizer (b).

Preferably, the thixotropic composition (A) consists of the bis-urea (a) and of the plasticizer (b) in the contents by weight shown above.

The bis-urea (a) is obtained by reaction of a primary aliphatic amine (a1) with a diisocyanate (a2) with a molar mass of less than 500 g/mol.

The chosen amine is preferably an n-alkylamine comprising from 1 to 22 carbon atoms and more preferably still n-butylamine

The diisocyanate (a2) which can be used can be aromatic or aliphatic and has the formula (II):

NCO—R⁶—NCO (II)

in which R⁶ is chosen from one of the following divalent radicals, the formulae of which below show the two free valencies:
a) the divalent radical derived from isophorone;

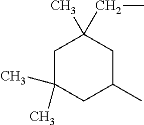

b) the divalent radical 4,4′-methylenebis(cyclohexyl);

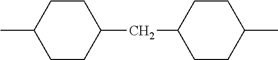

c) the divalent radical derived from toluene-2,4-diisocyanate (or 2,4-TDI) or from toluene-2,6-diisocyanate (or 2,6-TDI) of respective formulae:

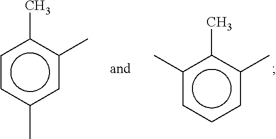

d) the divalent radical derived from diphenylmethylene-4,2′-diisocyanate (or 4,2′-MDI) or from diphenylmethylene-4,4′-diisocyanate (or 4,4′-MDI), of formulae:

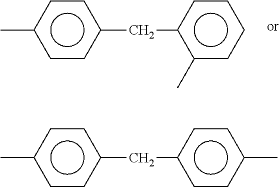

e)
—(CH₂)₆— (or hexamethylene radical);
f)

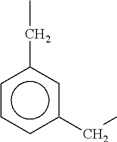

(or m-xylylene radical);
g)

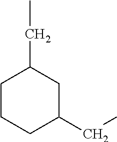

(or hexahydro-m-xylylene radical).

Diphenylmethylene-4,4′-diisocyanate (or 4,4′-MDI), corresponding to one of the formulae d) above, is particularly preferred.

The plasticizer (b) is chosen from plasticizers known to a person skilled in the art and which are, advantageously, commercially available.

Preference is given, among the alkyl phthalates, to the use of DiIsoDecyl Phthalate (DIDP).

As regards pentaerythritol tetravalerate, mention may be made of the product sold under the brand name Pevalen® by Perstorp.

As regards an ester of alkylsulfonic acid and of phenol, mention may be made of the product Mesamoll® sold by Lanxess.

As regards diisononyl 1,2-cyclohexanedicarboxylate, mention may be made of the product sold under the name Hexamoll Dinch® by BASF.

3,3′-[Methylenebis(oxymethylene)]bis[heptane] can be identified by its CAS number: 22174-70-5, and is also known under the trade name of 2-ethylhexylal, available from Lambiotte.

Finally, dioctyl carbonate (European Chemical Number or EC Number: 434-850-2) is available from BASF.

According to a very particularly preferred alternative form, the plasticizer (b) is DiIsoDecyl Phthalate (DIDP).

According to another embodiment, the thixotropic composition (A) comprises, and preferably consists of, from 10% to 30% by weight of the bis-urea (a) and from 70% to 90% by weight of the plasticizer (b).

The thixotropic composition (A) employed in the PU2K structural adhesive composition according to the invention can be prepared in the following way.

The reaction of the aliphatic amine a1) with the diisocyanate a2) is highly exothermic. To prevent the large amount of heat formed by the reaction from leading to the decomposition of the bis-urea formed, the compounds a1) and a2) are each dissolved in the plasticizer b), prior to them reacting together, said plasticizer b) thus serving to evacuate the heat formed by the reaction. The two solutions in the plasticizer b) of the compounds a1) and a2) are advantageously each introduced into a reactor via injectors, under a pressure of 40 to 200 bar, preferably of 80 to 120 bar, the two solutions thus being brought into contact in the sprayed liquid state. The amounts of reactants preferably correspond to a (number of moles of a1)/(number of moles of a2) ratio equal to approximately 2. The bis-urea is produced by the reaction in the form of solid particles dispersed in a continuous phase of plasticizer b), the Brookfield viscosity of the corresponding suspension, measured at the temperature of 23° C., being generally of between 1 and 50 Pa·s, preferably between 10 and 25 Pa·s.

According to a preferred embodiment, the —NCO component and the hardener component each comprise from 0.5% to 35% by weight of said thixotropic composition (A), based on the total weight of the corresponding component, and more preferentially still from 2% to 15% by weight.

Alumina (B):

The two-component polyurethane structural adhesive composition (PU2K) according to the invention is such that at least one component, among its —NCO component and its hardener component, comprises from 5% to 40% by weight of alumina (B), based on the total weight of said component, and preferably

According to a preferred alternative form, the alumina (B) is included in the hardener component, more preferably at a content of from 10% to 35% by weight, based on the total weight of said component.

The alumina (B) employed is a standard alumina, which is generally provided in a pulverulent form, the solid particles of which have a diameter which can vary from 0.2 μm to 50 μm, more particularly from 0.5 μm to 25 μm, the median diameter D50 often being of between 2 and 5 μm, for example in the vicinity of 3 μm.

The alumina (B) can, for example, be obtained commercially from Huber under the name Martoxid™200.

Other Ingredients of the —NCO Component and of the Hardener Component:

The —NCO and hardener components of the PU2K structural adhesive composition according to the invention can each comprise at least one additive chosen from the group consisting of solvents, pigments, microspheres, adhesion promoters (such as, for example, alkoxysilanes), moisture absorbers, UV stabilizers (or antioxidants), dyes, fillers and their mixtures.

According to one embodiment, the —NCO and hardener components each comprise at least one filler chosen from mineral fillers, organic fillers and their mixtures.

Use may be made, by way of example of mineral fillers which can be used, of any mineral fillers customarily used in the field of adhesive compositions. These fillers are typically provided in the form of particles of diverse geometry. They can, for example, be spherical or fibrous or exhibit an irregular shape.

Preferably, the filler(s) is (are) chosen from the group consisting of clay, quartz, carbonate fillers, kaolin, gypsum, clays, zeolites, molecular sieves and their mixtures. Preferentially, the filler is chosen from zeolites and/or carbonate fillers, such as alkali metal or alkaline earth metal carbonates, and more preferentially calcium carbonate or chalk. Mention may be made, by way of example of calcium carbonate filler, of the product sold by Omya, under the name Omya BSH, the mean particle size of which is 2.4 μm. Siliporite SA 1720, available from Arkema, is an example of commercial synthetic zeolite which can also be used as filler. It is provided in the form of a 3 angstrom molecular sieve of type A.

These fillers can be untreated or treated, for example treated using an organic acid, such as stearic acid, or a mixture of organic acids predominantly consisting of stearic acid.

Use may also be made of hollow mineral microspheres, such as hollow glass microspheres, and more particularly of those made of calcium sodium borosilicate or of aluminosilicate.

Use may be made, by way of examples of organic fillers which can be used, of any organic and in particular polymeric fillers customarily used in the field of adhesive compositions.

Use may be made, for example, of aramid fibers, such as Kevlar®, polyvinyl chloride (PVC), polyolefins, rubber or ethylene/vinyl acetate (EVA).

Use may also be made of hollow microspheres made of expandable or nonexpandable thermoplastic polymer. Mention may in particular be made of hollow microspheres made of vinylidene chloride/acrylonitrile.

The mean particle size of fillers which can be used is preferably less than or equal to 100 microns, preferentially less than or equal to 30 microns and advantageously less than or equal to 10 microns.

The mean particle size is measured for a volume particle size distribution corresponding to 50% by volume of the sample of particles which is analyzed. When the particles are spherical, the mean particle size corresponds to the median diameter (D50 or Dv50), which corresponds to the diameter such that 50% of the particles by volume have a size which is smaller than said diameter. In the present patent application, this value is expressed in micrometers and determined according to the standard NF ISO 13320-1 (1999) by laser diffraction on an appliance of Malvern type.

Each of the —NCO and hardener components can comprise a total amount of filler(s) ranging from 1% to 40% by weight, preferentially from 1% to 30% by weight, with respect to the total weight of the corresponding component.

In addition, according to a preferred embodiment, the hardener component can comprise a crosslinking catalyst. The crosslinking catalyst which can be used can be any catalyst known by a person skilled in the art for catalyzing the formation of polyurethane and/or of a polyurea by reaction of at least one polyisocyanate and of at least one polyol and/or one polyamine.

Use may be made, for example, of one or more crosslinking catalysts chosen from the group consisting of:
organometallic catalysts;
amidines;
tertiary amines; and
their mixtures.

Preference is given, among the organometallic catalysts, to those not comprising tin. The organometallic compounds (compounds comprising at least one metal-carbon covalent bond) can comprise metal alkoxides, metal carboxylates and metal coordination complexes with one or more organic ligand(s). The metal atom is preferably chosen from aluminum, zinc, iron, bismuth, titanium, gold and zirconium. The organometallic catalysts can comprise several metal atoms, such as, for example, bismuth and zinc, like Borchi® Kat VP 0244 (mixture of zinc neodecanoate and bismuth neodecanoate) from Borchers.

Mention may in particular be made, among the amidines, of:
1,8-diazabicyclo[5.4.0]undec-7-ene (DBU):

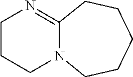 [SMILES: C1CCC2=NCCCN2CC1]

1,5-diazabicyclo[4.3.0]non-5-ene (DBN):

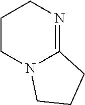

Mention may in particular be made, among the tertiary amines, of:
2,2′-dimorpholinodiethyl ether (DMDEE):

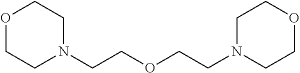 [SMILES: C1CN(CCOCCN2CCOCC2)CCO1]

1,4-diazabicyclo[2.2.2]octane (DABCO):

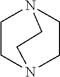

Preferably, the amount of crosslinking catalyst which can be used ranges from 0.01% to 1% by weight, more preferably from 0.05% to 0.5% by weight, with respect to the weight of the hardener component.

The PU2K structural adhesive composition according to the invention is advantageously substantially devoid of solvent. It is understood to mean by these terms that the solvent content of said adhesive does not exceed 1% weight/weight and preferably 0.05%.

PU2K Structural Adhesive Composition:

Each of the constituent —NCO and hardener components of the PU2K structural adhesive composition according to the invention is prepared separately, by simple mixing of its ingredients.

The —NCO component and the hardener component are packaged, for example in a dual cartridge. The dispensing of the adhesive takes place using a dual-cartridge gun. A homogeneous mixture of the two components is obtained by attaching a static mixer to the dual cartridge. The adhesive composition is obtained according to a process known to a person skilled in the art by reaction of the —NCO component with the hardener component in an NCO/(OH+NH) ratio ranging from approximately 0.90 to 1.20, preferably between 1.00 and 1.10, so that the ratio by volume of the —NCO component to the hardener component is preferentially close to 1. The NCO/OH+NH ratio is defined as being the ratio of the NCO functions (meq/g) of the —NCO component to the sum of the reactive OH (meq/g) and NH (meq/g) functions of the hardener component.

Another subject matter of the present invention is the use of the PU2K structural adhesive composition, as defined above, as structural adhesive in the field of construction, in the field of the manufacture of transportation means, preferably of the motor vehicle, rail and aerospace industries, and in the field of shipbuilding, more particularly for assemblies intended for the manufacture of batteries for electric cars or hybrid cars.

Finally, a subject matter of the present invention is a process for assembling two substrates by adhesive bonding, comprising:
the coating, onto at least one of the two substrates to be assembled, of the adhesive composition obtained by mixing the —NCO component and the hardener component, as are defined above; then
bringing the two substrates into actual contact.

The appropriate substrates are, for example, inorganic substrates, such as concrete, metals or alloys (such as aluminum alloys, steel, nonferrous metals and galvanized metals); or else organic substrates, such as wood, plastics, such as PVC, polycarbonate, PMMA, polyethylene, polypropylene, polyesters or epoxy resins; substrates made of metal and composites coated with paint (as in the motor vehicle sector, for example).

The invention is now described in the following implementational examples, which are given purely by way of illustration and should not be interpreted in order to limit the scope thereof.

### EXAMPLES

The following ingredients were used:
Tolonate® HDB, sold by Vencorex, is a polyisocyanate based on HDI of the biuret type with a mean functionality F=3.7, having an NCO percentage ranging from 22.5% to 24.5% and a residual HDI content<0.1%, and having a viscosity at 25° C. ranging from 1500 to 2500 mPa·s,
Voranol™ P 2000, sold by Dow, is a polypropylene glycol (PPG) of functionality F=2 having an OHN of 55 mg KOH/g, i.e. a number-average molecular weight (Mn) in the vicinity of 2040 g/mol,
Dianol® 330, sold by Ceca, is propoxylated (PPG) 4,4′-isopropylidenediphenol of functionality F=2 having an OHN of 280 mg KOH/g, i.e. a number-average molecular weight (Mn) in the vicinity of 401 g/mol,
Lupranol® 3402, sold by BASF, is a propoxylated ethylenediamine of functionality F=4 having an OHN of 470 mg KOH/g, i.e. a number-average molecular weight (Mn) in the vicinity of 480 g/mol,
Omya® BSH, from Omya, is a hydrophobic calcium carbonate with a mean particle size of 2.4 μm,
Siliporite® SA 1720 is a synthetic zeolite sold by Ceca, in the form of a 3 angström molecular sieve of type A,
Aerosil® R202, sold by Evonik, is a hydrophobic fumed silica with a (BET) specific surface in the vicinity of 100 m²/g,
Borchi® Kat VP 0244, catalyst consisting of a mixture of zinc neodecanoate and bismuth neodecanoate, from Borchers,
Martoxid™ 200, alumina from Huber, the solid particles of which have a diameter of from 0.5 μm to 25 μm and a median diameter D50 of approximately 3 μm.

### Example A1 (Reference): Preparation of the —NCO Component

The ingredients constituting the —NCO component are mixed, in the proportions shown in table 1, in a reactor kept constantly stirred and under nitrogen.

After homogenization of the mixture, the content of NCO group in the —NCO component (expressed as percentage by weight, with respect to the weight of the —NCO component (% NCO)) is measured according to the standard NF T52-132.

### Example A2 (Reference): Preparation of the —OH Component (Hardener)

The ingredients constituting the —OH component are mixed, in the proportions shown in table 2, in a reactor kept constantly stirred and under nitrogen.

After homogenization of the mixture (approximately 3 hours), the content of OH group in the —OH component, expressed in milligrams of KOH per gram of —OH component (mg KOH/g), is measured.

### Example A3 (Comparative): Preparation and Evaluation of a PU2K Adhesive Composition

Preparation:

The —NCO component prepared in example A1 and the —OH component prepared in example A2 were mixed in a proportion of an —NCO/—OH molar equivalent ratio equal to 1, which corresponds to an —NCO component/—OH component ratio by weight equal to 100 g of —NCO component per 95.6 g of —OH component. The corresponding proportions are shown in table 3.

The mixing is carried out via the use of a 50 ml dual cartridge at a temperature of approximately 23° C.

TABLE 1
—NCO component

| | Content (as % weight/weight) | |
|---|---|---|
| Ingredients | Example A1 | Example 1 |
| Tolonate ® HDB | 76.0 | 76.0 |
| Siliporite ® SA 1720 | 8.5 | 5 |
| Aerosil ® R202 | 1.5 | — |
| Thixotropic composition of example A | — | 5 |
| Omya ® BSH | 14.0 | 14.0 |
| Total | 100 | 100 |
| Content by weight of —NCO | 16.72 | 16.72 |
| (as % weight/weight) | | |

TABLE 2
—OH component (hardener component)

| | Content (as % weight/weight) | |
|---|---|---|
| Ingredients | Example A2 | Example 2 |
| Voranol ™ P2000 | 15.00 | 15.00 |
| Lupranol ® 3402 | 38.74 | 38.74 |
| Dianol ® 330 | 8.00 | 8.00 |
| Siliporite ® SA 1720 | 5.18 | 5.15 |
| Aerosil ® R202 | 1.45 | — |
| Thixotropic composition of example A | — | 5.00 |
| Omya ® BSH | 31.52 | |
| Martoxid ™ 200 | — | 28.00 |
| Borchi ® Kat VP 0244 | 0.11 | 0.11 |
| Total | 100 | 100 |
| Content by weight of —OH | 212.8 | 212.8 |
| (in mg KOH/g) | | |

TABLE 3
Two-component polyurethane structural
adhesive compositions (PU2K)

| | | Example 3 |
|---|---|---|
| | Example A3 | (according to |
| Component | (comparative) | the invention) |
| —NCO component | Example A1 | Example 1 |
| —OH component | Example A2 | Example 2 |
| —NCO/—OH molar equivalent ratio | 1 | 0.97 |
| —NCO component/—OH component | 100/95.6 | 100/92.2 |
| ratio by weight | | |
| Flow after extrusion (in g/minute) | 450 | 210 |
| Creep distance (in cm) according to | 3 | 0 |
| ASTM D 2202 | | |
| Tensile stress at break (MPa) | 25 | 23 |
| Elongation at break (%) | 5 | 10 |
| Thermal conductivity | 0.5 | 0.8 |
| (in W · m⁻¹ · K⁻¹) | | |

Evaluation:

The comparative PU2K adhesive composition A3 thus obtained is subjected to the tests and measurements described below.

a) Flow of the Noncrosslinked PU2K Composition After Extrusion:

The aim of the test employed is to assess the extrudability, through the nozzle, of the composition of example A3 packaged as a dual cartridge, under the effect of the pressure exerted by the piston, which is integral with the trigger of the gun actuated by the operator. The pressure exerted is 3 bar.

The flow rate measured is shown in g/minute in table 3 and corresponds to behavior which is entirely in accordance.

b) Creep of the Noncrosslinked PU2K Composition:

The creep (or sagging or slump) of the viscous composition of example A3 is measured according to the standard ASTM D 2202. For this, said composition is introduced into the cavity of the measuring jig of the standard placed in a horizontal position, then the piston is advanced so as to form a composition cylinder with a diameter of 38.1 mm and a thickness of 4.75 mm, ready to flow downward, under the effect of gravity, along the surface of the instrument, which is provided with a graduated scale. The jig is subsequently immediately placed in a vertical position for 15 minutes at 23° C. At the end of this period of 15 minutes, a measurement is made, using the graduated scale, of the maximum creep point of the initial cylinder formed by the composition.

Significant creeping of the composition is observed, corresponding to a distance measured on the graduated scale of the instrument of 3 cm, which result is shown in table 3.

c) Intrinsic Mechanical Performance Qualities of the Crosslinked PU2K Composition:

The measurements of tensile stress at break and of tensile elongation tension at break were carried out according to the standard ISO 37 (2012).

The principle of the measurement consists in drawing, in a tensile testing device, the movable jaw of which moves at a constant rate equal to 10 mm/minute, a standard test specimen consisting of the crosslinked composition of example A3 and in recording, at the moment when the test specimen breaks, the tensile stress applied (in MPa) and also the elongation of the test specimen (in %). The standard test specimen is dumbbell-shaped, as illustrated in the international standard ISO 37. The narrow part of the dumbbell used has a length of 20 mm, a width of 4 mm and a thickness of 3 to 4 mm.

The results obtained are shown in table 3 and correspond to values highly representative of a PU2K structural adhesive.

d) Thermal Conductivity of the Crosslinked PU2K Composition:

The thermal conductivity is measured by a hot-wire conductivity meter, such as the FP2C manufactured by Neotim.

The hot-wire probe is sandwiched between two test specimens of the crosslinked composition of example A3 in the shape of a parallelepiped with dimensions of 80×40×5 mm, and conditioned beforehand for 1 week at ambient temperature.

The thermal conductivity measured is shown in table 3 in W/mK.

### Example A (Reference): Thixotropic Composition (A) Consisting of a Suspension of 23.3% Weight/Weight of Bis-Urea in DIDP

The following are first of all prepared:
a solution A of n-butylamine in DIDP, consisting of 17.17% weight/weight of n-butylamine and of 82.83% weight/weight of DIDP, then
a solution B of 4,4′-MDI in DIDP, consisting of 29.46% weight/weight of 4,4′-MDI in 70.34% weight/weight of DIDP.

The two solutions A and B are heated to 100° C. and then introduced, each under a pressure of 100 bar, into a reactor, in which they are sprayed continuously over one another in a ratio A/B=50.1/49.9 by weight, corresponding to an n-butylamine/MDI molar ratio equal to 2. The reaction is immediate and the temperature of the reactor reaches 140° C. at the end of manufacture.

At the reactor outlet, a stable 23.3% weight/weight dispersion of a bis-urea in DIDP is obtained, the bis-urea being of formula:

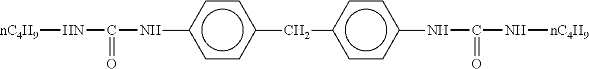

The Brookfield viscosity of the suspension, measured at 23° C., is 15 Pa·s.

### Example 1: Preparation of the —NCO Component Incorporating the Thixotropic Composition of Example A:

Example A1 is repeated with the ingredients and their contents shown in table 1.

### Example 2: Preparation of the Hardener Component Incorporating the Thixotropic Composition of Example A:

Example A2 is repeated with the ingredients and their contents shown in table 2.

### Example 3 (According to the Invention): Preparation and Evaluation of a PU2K Adhesive Composition Consisting of the —NCO Component of Example 1 and of the Hardener Component of Example 2:

Example A3 is repeated with the —NCO component of example 1 and the hardener component of example 2 in the proportions shown in table 3.

The results obtained for the tests are also shown in table 3 and reveal:
a flow after extrusion which is admittedly lower than that of example A3 but nevertheless entirely acceptable;
an absence of creep, unlike example A3;
a tensile stress at break and an elongation at break which are similar to those obtained for the adhesive composition of example A3, which thus also correspond to values which are entirely representative of a PU2K structural adhesive; and
a very greatly increased (by 60%) thermal conductivity, compared to that of example A3.

1-15. (canceled)

16. A two-component polyurethane structural adhesive composition (PU2K) consisting of an —NCO component and of a hardener component, characterized in that:
the —NCO component and the hardener component each comprise from 0.1% to 40% by weight, based on the total weight of the corresponding component, of a thixotropic composition (A) comprising, based on its total weight:
from 1% to 40% by weight of a bis-urea (a) obtained by reaction of a primary aliphatic amine (a1) with a diisocyanate (a2) with a molar mass of less than 500 g/mol, and
from 60% to 99% by weight of a plasticizer (b) chosen from:
an alkyl phthalate,
pentaerythritol tetravalerate,
an ester of alkylsulfonic acid and of phenol,
diisononyl 1,2-cyclohexanedicarboxylate,
3,3′-[methylenebis(oxymethylene)]bis[heptane], and
dioctyl carbonate;
said thixotropic composition (A) being provided in the form of a suspension of solid particles of the bis-urea (a) in a continuous phase consisting of the plasticizer (b); and
at least one component, among the —NCO component and the hardener component, comprises from 5% to 40% by weight of alumina (B), based on the total weight of said component.

17. The PU2K structural adhesive composition as claimed in claim 16, characterized in that the —NCO component comprises a polyisocyanate selected from the group consisting of diisocyanates, triisocyanates and their mixtures.

18. The PU2K structural adhesive composition as claimed in claim 17, characterized in that the triisocyanates are selected from the group consisting of diisocyanate isocyanurates, adducts of diisocyanates and of triols, and biurets.

19. The PU2K structural adhesive composition as claimed in claim 18, characterized in that the triisocyanate included in the —NCO component is a hexamethylene diisocyanate (HDI) biuret.

20. The PU2K structural adhesive composition as claimed in claim 16, characterized in that the hardener component comprises a polyol or a mixture of polyols.

21. The PU2K structural adhesive composition as claimed in claim 20, characterized in that the polyol is a polyether polyol, the hydroxyl functionality of which ranges from 2 to 4.

22. The PU2K structural adhesive composition as claimed in claim 21, characterized in that the hardener component comprises:
at least two polyether polyols P1 each having a number-average molecular weight strictly of less than 500 g/mol, said polyether polyols P1 being such that:
at least one polyether polyol P1 comprises at least three hydroxyl functions; and
at least one polyether polyol P1 comprises at least two hydroxyl functions; and
at least one polyether polyol P2 has a number-average molecular weight strictly of greater than 1000 g/mol.

23. The PU2K structural adhesive composition as claimed in claim 16, characterized in that the thixotropic composition (A) is such that the bis-urea (a) is obtained by reaction of an n-alkylamine (a1) comprising from 1 to 22 carbon atoms with a diisocyanate (a2) of formula (II):
NCO—R⁶—NCO (II)
in which R⁶ is chosen from one of the following divalent radicals, the formulae of which below show the two free valencies:
a) the divalent radical derived from isophorone; 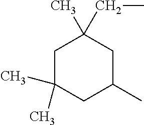
b) the divalent radical 4,4′-methylenebis(cyclohexyl); 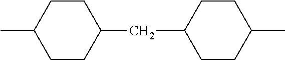
c) the divalent radical derived from toluene-2,4-diisocyanate (or 2,4-TDI) or from toluene-2,6-diisocyanate (or 2,6-TDI) of respective formulae: 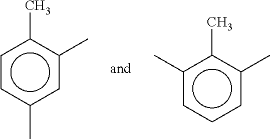
d) the divalent radical derived from diphenylmethylene-4,2′-diisocyanate (or 4,2′-MDI) or from diphenylmethylene-4,4′-diisocyanate (or 4,4′-MDI), of formulae: 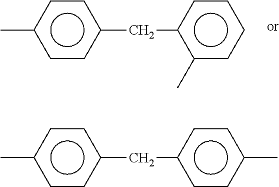
e)
—(CH₂)₆— (or hexamethylene radical);
f) 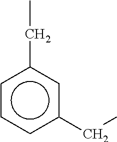
(or m-xylylene radical);
g) 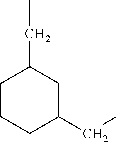
(or hexahydro-m-xylylene radical).

24. The PU2K structural adhesive composition as claimed in claim 16, characterized in that the thixotropic composition (A) is such that the plasticizer (b) is DiIsoDecyl Phthalate.

25. The PU2K structural adhesive composition as claimed in claim 16, characterized in that the thixotropic composition (A) comprises, from 10% to 30% by weight of the bis-urea (a) and from 70% to 90% by weight of the plasticizer (b).

26. The PU2K structural adhesive composition as claimed in claim 16, characterized in that the —NCO component and the hardener component each comprise from 0.5% to 35% by weight of the thixotropic composition (A), based on the total weight of the corresponding component.

27. The PU2K structural adhesive composition as claimed in claim 16, characterized in that the alumina (B) is included in the hardener component.

28. The PU2K structural adhesive composition as claimed in claim 16, characterized in that the —NCO and hardener components each comprise at least one filler chosen from mineral fillers, organic fillers, and their mixtures.

29. A process for assembling two substrates by adhesive bonding, comprising:
the coating, onto at least one of the two substrates to be assembled, of the adhesive composition obtained by mixing the —NCO component and the hardener component, as are defined in claim 16; then
bringing the two substrates into actual contact.
